(19) United States
(12) Patent Application Publication
(10) Pub. No.: US 2026/0000129 A1
(43) Pub. Date: Jan. 1, 2026

(54) METHOD OF A FIRST AEROSOL GENERATION DEVICE FOR EXCHANGING DATA WITH A SECOND AEROSOL GENERATION DEVICE, COMPUTER PROGRAM AND AEROSOL GENERATION DEVICE

(71) Applicant: JT INTERNATIONAL SA, Geneva (CH)

(72) Inventors: Layth Sliman BOUCHUIGUIR, Bellevue (CH); Pier Paolo MONTICONE, Le Grand-Saconnex (CH)

(73) Assignee: JT INTERNATIONAL SA, Geneva (CH)

(21) Appl. No.: 18/881,319

(22) PCT Filed: Jul. 10, 2023
(86) PCT No.: PCT/EP2023/069017

§ 371 Date: Jan. 6, 2025

(30) Foreign Application Priority Data
Jul. 12, 2022 (EP) 22184385.7

(51) Int. Cl. A24F 40/65; A24F 40/10; A24F 40/20; A24F 40/53; A24F 40/60

(52) U.S. Cl. CPC A24F 40/65; A24F 40/53; A24F 40/60; A24F 40/10; A24F 40/20

(57) ABSTRACT

A method of a first aerosol generation device for exchanging data with a second aerosol generation device, the method comprising: activating a wireless communication interface of the first aerosol generation device while the first aerosol generation device is in a predetermined state, the predetermined state being related to aerosol generation; determining at least one trigger event has been detected by a detection unit of the first aerosol generation device different from the wireless communication interface; and performing data exchange with the second aerosol generation device via the wireless communication interface in response to detecting the at least one trigger event while the first aerosol generation device is in the predetermined state.

### TECHNICAL FIELD

The present invention generally relates to the field of aerosol generation devices. In particular, the present invention is directed to a method of a f first aerosol generation device for exchanging data with a second aerosol generation device, a computer program and an aerosol generation device.

### BACKGROUND

Aerosol generation devices, also referred to as inhalation devices, such as e-cigarettes, vaping devices and aerosol inhalers, are known.

Such aerosol generation devices conventionally include an atomizer, a power supply and a tobacco stick), liquid-filled capsule, or similar means disposed therein in order to generate an aerosol (that is, a vapour) that may be inhaled by the user. Such means may be referred to as an aerosol-generating article and may contain an amount of an aerosol-generating material.

The generated aerosol may contain, for example, a form of nicotine such that user of the inhalation device may, for example, simulate smoking tobacco by inhaling the generated aerosol.

### SUMMARY OF THE INVENTION

### Technical Problem

Aerosol generation devices are generally hand-held devices. In general, handheld aerosol generation devices have to be of a relatively small size and relatively low weight in order to be handheld. This can often result in aerosol generation devices having limited memory space and/or power supply, and/or a simple or minimal user interface.

As such, there is a general need to improve aerosol generation devices, for example, in terms of efficiency and/or functionality, while maintaining its small size and its light weight.

Recently, there is an introduce interest to new functionalities to aerosol generation devices. For example, manufacturers of aerosol generation devices may seek to allow exchange of data between devices of a multiple different users, for example, so as to stimulate interaction and gamification between users of aerosol generation devices, particularly heated tobacco stick (heated-tobacco stick) devices, or to allow exchange of data between different devices of a single user. This may lead to improved functionality of aerosol generation device.

The present inventors have recognised that enabling such new functionalities requires, in turn, a number of underlying technical problems to be solved. By way of non-limiting example, some functionalities may require facilitating wireless communication between devices as well as, for example, limiting data exchange to be performed only with particular devices and/or at particular times, and/or limiting the exchange to particular data only.

It may be further necessary to implement such wireless communication in a manner that is readily controllable be a user of the aerosol generation device, even where the device has a simple or minimal user interface, and that helps to ensure safety of a user's data.

Therefore, in order to facilitate such new functionalities, there exists a need to enabling secure and convenient data exchange between aerosol generation devices.

### Summary of the Solution

The present invention is intended to address one or more of the above technical problems.

In particular, in view of the limitations discussed above, the present inventors have devised, in accordance with a first example aspect herein, a method of a first aerosol generation device for exchanging data with a second aerosol generation device. The method comprises activating a wireless communication interface of the first aerosol generation device while the first aerosol generation device is in a predetermined state, the predetermined state being related to aerosol generation. The method further comprises determining at least one trigger event has been detected by a detection unit of the first aerosol generation device different from the wireless communication interface. The method further comprises performing data exchange with the second aerosol generation device via the wireless communication interface in response to detecting the at least one trigger event while the first aerosol generation device is in the predetermined state.

The present inventors have further devised, in accordance with a second example aspect herein, a computer program which, when the program is executed by a control unit of an aerosol generation device, cause the control unit to perform the method according to the first example aspect herein.

The present inventors have further devised, in accordance with a third example aspect herein, an aerosol generation device comprising a wireless communication interface, a detection unit, a memory section, and a control section. The control section is configured to control the aerosol generation device to perform a method according to the first example aspect herein.

According to the aspects disclosed herein, in order for data exchange to be performed, two conditions must be met. In particular, the first aerosol generation device must be in a predetermined state related to aerosol generation. Furthermore, at least one trigger event must be detected by the detection unit while the first aerosol generation device is in said predetermined state. Data exchange is only performed when both of these conditions are satisfied. Therefore, aspects of the present invention enable secure and convenient data exchange between aerosol generation devices that is readily controllable by the aerosol generation device and the user.

For example, aspects of the present invention may help to avoid situations in which a user inadvertently controls the aerosol generation device to perform data exchange or in which the aerosol generation device is caused to activate the wireless communication interface by an undesired transmission received from another device because data exchange is only performed when both of the above-mentioned conditions are satisfied. This may, in turn, help to ensure safety of a user's data.

Furthermore, aspects of the present invention may also help to limit the situations and, thus, the amount of time during which the wireless communication interface is activated and/or during which the aerosol generation device performs data exchange. This may in turn help to improve a battery life of the aerosol generation device.

Furthermore, by relying on a predetermined state related to aerosol generation and a detection unit of the aerosol generation device, these advantages may be achieved in a manner that is specifically adapted to common use and components of aerosol generation devices. This may help to avoid increases in weight or size of the device by limiting the need to introduce additional components or any increase in the complexity of the user interface.

### BRIEF DESCRIPTION OF THE DRAWINGS

Embodiments of the invention will now be explained in detail, by way of non-limiting example only, with reference to the accompanying figures, described below. Like reference numerals appearing in different ones of the figures can denote identical or functionally similar elements, unless indicated otherwise.

FIG. 1A is a schematic illustration of an aerosol generation device, according to an example aspect herein.

FIG. 1B is a block diagram illustrating components of an aerosol generation device, in accordance with an example aspect herein.

FIG. 2 is a flow diagram illustrating a process by which the aerosol generation device 100 of FIG. 1A may exchange data with a second aerosol generation device, in accordance with an example aspect herein.

FIG. 3 is a graph illustrating the various phases of aerosol generation by the aerosol generation device.

### DETAILED DESCRIPTION

Example embodiments of the present invention will now be described in detail with reference to the accompanying drawings.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

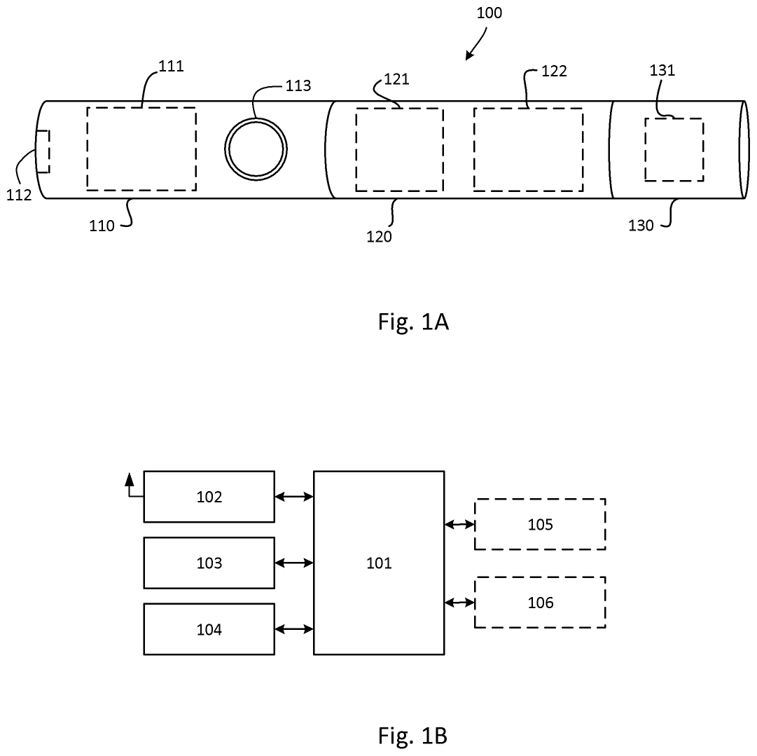

FIG. 1A is a schematic illustration of an aerosol generation device 100, according to an example aspect herein.

The aerosol generation device 100 is a handheld device that is configured to generate an aerosol (that is, a vapour) that may be inhaled by a user of the aerosol generation device 100. The aerosol generation device 100 comprises a power supply unit 110, an aerosol generation unit 120 and a mouthpiece 130.

The power supply unit 110 may, as in the present example embodiment, comprise a power supply 111, a terminal 112 and an input means 113. By way of example, the input means 113 may, as in the present example embodiment, comprise a button.

The power supply 111 may, as in the present example embodiment, be a rechargeable power supply. The power supply 111 may, as in the present example embodiment, be a lithium ion secondary battery. Alternatively, the power supply 111 may be, for example, a chargeable secondary battery and/or an electric double layer capacitor (EDLC).

The terminal 112 may, as in the present example embodiment, comprise a power terminal for use in charging the power supply 111. That is, the terminal 112 may, as in the present example embodiment, be electrically connectable to an external device, such as an aerosol generation device case, or the mains power supply and be configured to receive power to charge the power supply 111. By way of example, the terminal 112 may include one or more of a USB terminal, a micro USB terminal, a wireless charging terminal, etc. It should be noted that the combination of wired terminal (e.g., a USB terminal or a micro USB terminal) and wireless terminal (e.g., a wireless charging terminal) can be adopted as the terminal 112.

Optionally, the terminal 112 may, as in the present example embodiment, comprise a data terminal to enable transmission of data to and reception of data from an external device connected to the aerosol generation device 100 via the terminal 112.

The aerosol generation unit 120 may, as in the present example, comprise aerosol-generating article 122 containing an amount of an aerosol-generating material and a load 121 for atomizing the aerosol-generating material in the aerosol-generating article 122. Power is provided to the load 121 by the power supply unit 110.

By way of example, the aerosol-generating article 122 may comprise a reservoir or a capsule for storing an aerosol-generating material in liquid form. Alternatively, the aerosol-generating material may comprise a tobacco stick (also referred to as a “heatable tobacco stick”, “a heated-tobacco stick”, etc.), a gel-like composition in a capsule or pod, or similar means, depending on the type of aerosol generation device.

The load 121 atomizes the aerosol-generating material (for example, by heating) thereby generating an aerosol which passes through the mouthpiece 130 in response to the inhalation action of the user. In one example, the load 121 is represented by the electrical load of a heating element, i.e. the energy consumed by the heating element. The heating element may be resistive, inductive, etc.

The aerosol generation device 100 may, as in the present example embodiment, be a so-called “e-vapour” device. Alternatively, the aerosol generation device may be a so-called “T-vapor” device, also commonly referred to as a Heat-not-Burn device or a heated tobacco device.

The mouthpiece 130 may, as shown in FIG. 1A, comprise a flavour source 131. The flavour source 131 may, for example, contain grains of shredded raw tobacco or another plant (e.g. mint or herbs) and/or flavours such as menthol such that, a flavour is added to the aerosol as it passes through the flavour source 131. Furthermore, the mouthpiece 130 may contain any suitable inhalation ports, etc. (not shown) required for the user to inhale the generated aerosol.

The power supply unit 110, the aerosol generation unit 120 and the mouthpiece 130 may be detachable such that individual units may be readily replaced. Additionally or alternatively, aerosol-generating article 122 and/or the aerosol-generating material stored therein and flavour source 131 may be detachable from their respective units and replaceable.

While the aerosol generating unit 120 and the mouthpiece 130 of the aerosol generation device 100 of FIG. 1A are shown as separate units, these two units may alternatively be provided as a single unit and flavour source 131 may optionally be provided with the aerosol-generating material in the aerosol-generating article 121. Alternatively, the mouthpiece 130 can be omitted.

FIG. 1B is a block diagram illustrating components of an aerosol generation device 100, in accordance with an example aspect herein.

As shown in FIG. 1B, the aerosol generation device 100 includes a control section 101, a wireless communication interface 102, a detection unit 103 and a memory section 104. Additionally, the aerosol generation device 100 may optionally comprise, as in the present example embodiment, an output section 105 and/or an input section 106.

The control section 101 may comprise one or more processing units (e.g. a central processing unit (CPU) such as a microprocessor, or microcontroller unit (MCU), or micro processing unit (MPU), or a suitably programmed field programmable gate array (FPGA) or application-specific integrated circuit (ASIC)).

The control section 101 may, as in the present example, be configured to control operation of the aerosol generation device 100. The control section 101 may, as in the present example embodiment, include separate modules or sections for each function performed.

By way of example, the control section 101 may control supply of power to the aerosol generation unit 120 and charging of supply the power 111. Additionally or alternatively, the control section 101 may control supply of power to components 102 to 106, output control signals to one or more of components 102 to 106, receive and process signals from one or more of components 102 to 106, and control operation of the aerosol generation device 100 based on the received signals. Alternatively, the control section 101 may not control the charging of the power supply 111. In this alternative embodiment, the charging of the power supply 111 may be controlled by the external device.

The wireless communication interface 102 may be configured to transmit and receive information by any suitable wireless communication means known to those versed in the art. For example, the wireless communication interface 102 may transmit or receive via information a direct communication link provided by any suitable wireless connection, e.g. a Bluetooth™, Bluetooth Low Energy (BLE), NFC, or NR connection, or an indirect communication link (which may be provided by a network comprising a Local Area Network (LAN), a Wide Area Network (WAN) and/or the Internet). Furthermore, wireless communication interface 102 may comprise processing and communication functionalities necessary to operate in accordance with one or more conventional telecommunication standards, including—but not limited to—GSM, PCS, 3GPP, LTE, LTE-A, UMTS, 3G, 4G, 5G.

The detection unit 103 may, as in the present example embodiment, comprise a sensor unit of the aerosol generation device 100. By way of example, the sensor unit may comprise an accelerometer or other motion sensor. Additionally or alternatively, the sensor unit may include one or more of an inhalation sensor for use in detecting an inhaling action by a user of the aerosol generation device 100 and/or one or more of voltage and current sensors for use in detecting charging and discharging of the power supply 111 and/or connection of another device via the terminal 112.

Additionally or alternatively, the detection unit 103 may comprise an input unit of the aerosol generation device 100. That is, the input unit may comprise any means for allowing the aerosol generation device 100 to receive input from a user of the aerosol generation device 100. In such embodiments, the detection unit 103 may be example implemented as part of the input section 106 or provided separately to the input section 106.

By way of non-limiting example, the power supply unit 110 may comprise a button 113 as shown in FIG. 1A. Alternatively, the aerosol generation device 100 may comprise any suitable input such as one or more additional buttons, one or more switches, a touch pad or touch screen, or suitable combination of such input means.

More generally, the detection unit 103 may, as in the present example embodiment, not be a wireless communication interface. That is, detection unit 103 may, as in the present example embodiment, have a function that is not wireless communication and is a functionally separate component to the wireless communication interface 102.

The memory section 104 may, as in the present example, comprise both volatile and non-volatile memory resources. By way of example, memory section 104 may comprise a working memory (e.g. a random access memory). In addition, the memory section 104 may include an instruction store an electrically-erasable (e.g. a ROM in the form of programmable read-only memory (EEPROM) or flash memory) storing a computer program comprising the computer-readable instructions which, when executed by the control section 101, cause the control section 101 to perform various functions as described herein.

The output section 105 may, as in the present example embodiment, comprise any means known in the art suitable for outputting information to a user. By way of example, the outputting section may comprise one or multiple units including one or more of a display unit (e.g. an LCD screen or a touchscreen), a speaker unit (e.g. one or more of loudspeakers (e.g. one or more of moving coil loudspeakers, buzzers, horns and sounders), a lighting unit (e.g. one or more LEDs), and a haptic feedback unit (e.g. an eccentric rotating mass, ERM, vibration motor and/or a linear resonant actuator, LRA, vibration motor).

The input section 106 may, as in the present example embodiment, comprise any of the means for allowing the aerosol generation device 100 to receive input from a user of the aerosol generation device 100 discussed above in relation to the detection unit 103.

In FIG. 1B, the wireless communication interface 102, the detection unit 103 the memory section 104, the output section 105 and the input section 106 are shown separately to the control section 101. Alternatively, one or more of these components may be integrated with the control section 101.

In addition, the components 101 to 106 shown in FIG. 1B may be provided in any of units 110, 120 and 130 of the aerosol generation device 100 of FIG. 1A. By way of example, components 101 to 106 shown in FIG. 1B may be provided in the power supply unit 110 of the aerosol generation device 100. Although not shown in FIG. 1B, each of the components 101 to 106 of the aerosol generation device 100 may receive power from the power supply 111.

By way of further example, in some example embodiments, the aerosol generation device 100 further comprises an aerosol generation device case. In such example embodiments, the wireless communication interface 102 may be mounted on the aerosol generation device case. As will be discussed in more detail below, mounting the wireless communication interface 102 on aerosol generation device case side may advantageous in terms of sanitary aspects. Mounting the wireless communication interface 102 on aerosol generation device 100 side may be preferable in terms of easiness use.

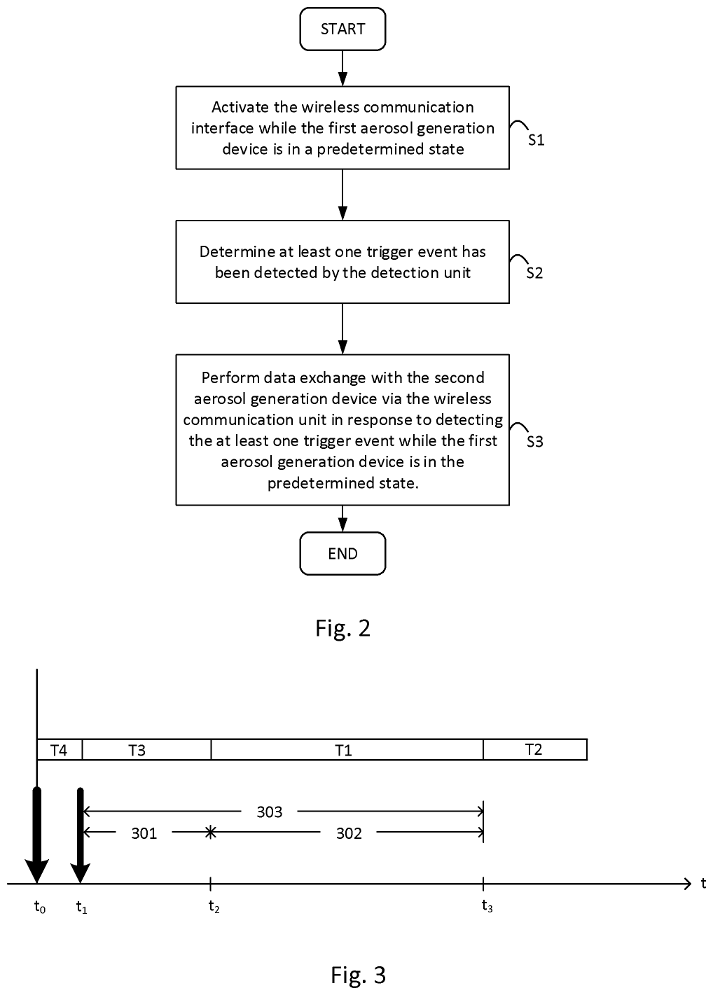

FIG. 2 is a flow diagram illustrating a process by which the aerosol generation device 100 of FIG. 1A may exchange data with a second aerosol generation device (not shown in Figures), in accordance with an example aspect herein.

In process step S1 of FIG. 2, the control section 101 activates a wireless communication interface 102 of the first aerosol generation device 100 while the first aerosol generation device 100 is in a predetermined state, the predetermined state being related to aerosol generation.

By way of example, the predetermined state may be a state of operation of the aerosol generation device. That is, the predetermined state may be a state that is defined with respect to the operation of the aerosol generation device 100 to generate aerosol or with respect to an aerosol generating session (also referred to as a vaping session) of the aerosol generation device 100.

FIG. 3 is a graph illustrating the various phases of aerosol generation by the aerosol generation device 100. As shown in FIG. 3, the aerosol generation session 300 comprises two phases, namely a preheating phase 301 and an aerosol generation phase 302.

By way of example, during the preheating phase 301, the control unit 101 controls supply of power from the power supply 111 to the load 121 in order to heat the load to a suitable temperature for aerosol generation. In FIG. 3, the preheating phase 301 is started at time t₁ and ends at time t₂. For example, the length of time of the preheating phase 301 may be dependent on the configuration of the aerosol generation device 100.

During the aerosol generation phase, the control unit 101 may, for example, control the aerosol generation unit 120 to generate an aerosol for inhalation by a user. In FIG. 3, the aerosol generation phase 303 is started at time t₂ and ends at time t₃. For example, the length of time of the aerosol generation phase 302 may be dependent on the configuration of the aerosol generation device 100 and/or safety requirements such as a maximum allowed inhalation time of a user.

The predetermined state may, as in the present example embodiment, comprise a state in which the first aerosol generation device is generating aerosol.

In the example of FIG. 3, the aerosol generation device 100 may be determined to be in the state in which the first aerosol generation device is generating aerosol during the time period T1, which corresponds to the aerosol generation phase 302.

In example embodiments in which the predetermined state comprises the state in which the first aerosol generation device is generating aerosol, the control section 101 may be configured to determine that the first aerosol generation device is in the state in which the first aerosol generation device is generating aerosol during a predetermined period defined based on at least one of:
(i). a supply of power to a heating element of the first aerosol generation device;
(ii). a detection of a user input in response to which first aerosol generation device initiates aerosol generation; and/or
(iii). a detection of an action by a user in response to which first aerosol generation device initiates aerosol generation.

For example (i), the aerosol generation device 100 may be provided with appropriate sensors, clocks and/or other means to enable the control section 101 to use, for example, a length of time for which power is supplied to the load 121, a resulting temperature increase in the load 121, etc. to determine the state in which the first aerosol generation device is generating aerosol, that is the aerosol generation phase 302 shown in FIG. 3.

For example (ii), the control section 101 may, as shown in FIG. 3, receive a user input in response to which first aerosol generation device initiates aerosol generation at time t₁. The control section 101 may, for example, determine the state in which the first aerosol generation device is generating aerosol based on a known length of time of the pre-heating phase 301, a length of time for which power is supplied to the load 121, a resulting temperature increase in the load 121, etc. and the time t₁.

By way of example, a user input in response to which first aerosol generation device initiates aerosol generation may comprise, for example, actuating the button 113 as shown in FIG. 1A. Alternatively, the aerosol generation device 100 may comprise any suitable input unit such as one or more additional buttons, one or more switches, a touch pad or touch screen, or suitable combination of such input means and the user input may comprise input via any such input means.

For example (iii), the control section 101 may, as shown in FIG. 3, detect an action by a user in response to which first aerosol generation device initiates aerosol generation at the time t₁. The control section 101 may, for example, determine the state in which the first aerosol generation device is generating aerosol based on a known length of time of the pre-heating phase 301, a length of time for which power is supplied to the load 121, a resulting temperature increase in the load 121, etc. and the time t₁.

By way of example, an action by a user in response to which first aerosol generation device initiates aerosol generation may comprise detection of inhalation by an inhalation sensor. Alternatively, an action by a user in response to which first aerosol generation device initiates aerosol generation may comprise detection of removal of, for example, a cover of the mouthpiece 130 or another element of the aerosol generation device 100 comprising an inhalation port. The aerosol generation device 100 may be provided with any suitable sensors to perform such detection.

Additionally or alternatively, the predetermined state may comprise a state comprising a predetermined duration after the first aerosol generation device terminates generating aerosol.

By way of example, the predetermined state may comprise only the predetermined duration. For example, the aerosol generation device 100 may be determined to be in the predetermined state during the time period T2 in the example of FIG. 3. It may be that a user can concentrate inhalation of aerosol during the aerosol generation phase 303.

By way of alternative, the predetermined state may be defined so as to comprise one or more additional durations. For example, in the example of FIG. 3, the aerosol generation device 100 may be determined to be in the predetermined state during both the time period T1, which corresponds to the aerosol generation phase, and the time period T2, which corresponds to the predetermined duration.

The predetermined duration may, as in the present example embodiment, be shorter than a duration generating aerosol.

By way of further alternative, the predetermined state may comprise a state in which the first aerosol generation device is ready for generating aerosol.

For example, the first aerosol generation device 100 may determine that the first aerosol generation device 100 is ready for generating aerosol when an external power supply is disconnected. It this example, the external power supply is preferably configured that it can house or hold the aerosol generation 100, is device and portable. Additionally or alternatively, the first aerosol generation device 100 may determine that the first aerosol generation device 100 is ready for generating aerosol when an aerosol precursor (e.g. aerosol-generating article 122 shown in FIG. 1A) is inserted into the first aerosol generation device.

In the example of FIG. 3, first aerosol generation device 100 may enter the state in which the first aerosol generation device 100 is ready for generating aerosol at time to. Time to may represent the time at which, for example, an external power supply is disconnected or at which an aerosol precursor is inserted into the first aerosol generation device. The predetermined state may then be defined so as to comprise at least time period T4 and, optionally, at least one of time periods T3, T1 and T2.

By way of further example, the predetermined state may comprise a state in which the first aerosol generation device 100 is activated by an input unit of the first aerosol generation device 100.

By way of example, the first aerosol generation device 100 may be activated by an input unit in response to a user actuating the button 113 as shown in FIG. 1A or any other suitable input unit such as one or more additional buttons, one or more switches, a touch pad or touch screen, etc.

In the example of FIG. 3, such actuating may occur at time t₁. The aerosol generation device 100 may then be determined to be in the predetermined state for, for example, a predetermined period following such actuation, while a user I/O interface (e.g. a touch screen) of the aerosol generation device 100 is activated/awake, etc.

Turning back to FIG. 2, the wireless communication interface 102 may be activated only in response to the first aerosol generation device 100 being in or entering the predetermined state, that is in a case where the first aerosol generation device 100 is in the predetermined state. Correspondingly, the control section 101 may control the wireless communication interface 102 such that the wireless communication interface 102 is not activated prior to the predetermined stat being entered and/or when it is determined that the aerosol generation device 100 is no longer in the predetermined state. In other words, supply of power to a power supply terminal of the wireless communication interface 102 may be performed in response to the first aerosol generation device 100 being in or entering the predetermined state. Alternatively, transition of the wireless communication interface 102 from power save mode or sleep mode into active mode may be performed in response to the first aerosol generation device 100 being in or entering the predetermined state. This may in turn lead to a saving of stored energy in the power supply 111.

By way of example, activating the wireless communication interface 102 may cause the wireless communication interface 102 to listen for other devices. More specifically, the wireless communication interface 102 may listen for other devices which are transmitting within a wireless communication range of the first aerosol generation device 102. of By way example, where the wireless communication interface 102 is a BLE communication interface, the wireless communication interface 102 may listen for other devices in an advertising state.

In process step S2 of FIG. 2, the control section 101 determines at least one trigger event has been detected by a detection unit 103 of the first aerosol generation device 100 different from the wireless communication interface 102.

The trigger event may, as in the present example embodiment, not be an event of the wireless communication interface 102, e.g. a reception or transmission by the wireless communication interface 102. The trigger event may, as in the present example embodiment, be independent of the operation of the wireless communication interface 102.

By way of example, the detection unit 103 may, as in the present example embodiment, comprise a sensor unit of the first aerosol generation device 100 and the at least one trigger event may comprise a detection of a predetermined motion by the sensor unit.

More specifically, the detection unit 103 may comprise an accelerometer, gyroscope or any other suitable motion sensor. The detection unit 103 and may be configured to detect the user moving the aerosol generation device 100 in a particular manner, i.e. the predetermined motion.

The predetermined motion to be detected may be, for example, bumping the aerosol generation device 100 with another aerosol generation device (similar to a “cheers” motion with a drink), shaking the aerosol generation device 100, or any other suitable motion that is sufficiently outside normal use of the aerosol generation device 100 to reliably indicate a deliberate intention of the user.

In example embodiments in which the aerosol generation device 100 further comprises an aerosol generation device case, mounting the wireless communication interface 102 and/or the detection unit 103 on the aerosol generation device case may allow direct contact between the aerosol generation devices of different users during the predetermined motion to be avoided, thereby improving sanitary aspects.

Alternatively, mounting the wireless communication interface 102 and/or the detection unit directly on the aerosol generation device 100 may improve ease of use.

The sensor unit and/or the predetermined motion may, as in the present example embodiment, be independent of entering the predetermined state by the first aerosol generation device.

By way of alternative, the detection unit 103 may comprise an input unit of the first aerosol generation device 100, such as any of the input means previously discussed. In such example embodiments, the at least one trigger event may comprise additional input to the input unit by a user of the aerosol generation device 100, further to any input required by the user to initiate aerosol generation.

In process step S3 of FIG. 2, the control section 101 controls the aerosol generation device 100 performing data exchange with the second aerosol generation device via the wireless communication interface 102 in response to detecting the at least one trigger event while the first aerosol generation device 100 is in the predetermined state.

That is, the aerosol generation device 100 may exchange data with a second aerosol generation device within a wireless communication range of the first aerosol generation device 100.

For example, data exchange may, as in the present example embodiment, only be possible in a case where both the first and second aerosol generation device have detected a trigger while in a predetermined state, i.e. only where both the first and second aerosol generation device are being controlled to perform data exchange. By way of example, the second aerosol generation device may also be configured as described above in relation to aerosol generation device 100.

By way of further example, data exchange may only be possible in a case where same trigger event is detected by both the first and second aerosol generation device and/or both the first and second aerosol generation device are in the same predetermined state. For example, once data exchange is enabled for both the first and second aerosol generation device, information regarding the predetermined state and/or trigger event may be exchanged as part of a handshake procedure and data exchange may only be performed where these match.

Optionally, the aerosol generation device 100 may be further configured only to perform data exchange in a case where a detected signal strength of a signal received from the second aerosol generation device exceeds a threshold value (e.g. higher than X dB). By way of example, the threshold value may be set such that data exchange is only performed detected signal strength is while the sufficiently strong to allow reliable transmission. This may be advantageous in cases where the wireless communication interface 102 has a limited range.

The use of such a threshold value may be advantageous in that it requires the first and second aerosol generation device to be in lose proximity, i.e. within one another's communication range, to perform data exchange. Requiring the first and second aerosol generation devices to be in close proximity to exchange data may, in turn, help to avoid unintended data exchange resulting from, for example, malicious communication or unsolicited advertising from other devices having larger communication ranges.

By way of example, performing data exchange with the second aerosol generation device may comprise, as in the present example embodiment, transmitting an identifier of the first aerosol generation device 100 to the second aerosol generation device and/or receiving an identifier of the second aerosol generation device from the second aerosol generation device and storing the identifier of the second aerosol generation device in a memory section 104 of the first aerosol generation device 100. Depending on the wireless communication technology used, such steps may also be performed as part of a handshake procedure initiating communication.

Performing data exchange with the second aerosol generation device may further comprise, as in the present example embodiment, transmitting, to a server or other central entity, a request for contact information of a user of the second aerosol generation device, the request comprising the identifier of second aerosol generation device.

By way of further example, such a server or central entity may store the information of registered users of aerosol generation devices, including the identifier of each user. In such example embodiments, further exchange of data may be limited until a response is received from the server or central entity indicating that information of a user corresponding to the identifier of second aerosol generation device is register or otherwise approving further data exchange.

Additionally or alternatively, performing data exchange with the second aerosol generation device may further comprise, as in the present example embodiment, limiting the data exchange such that data exchange is performed only when the first aerosol generation device is in the state in which the first aerosol generation device is generating aerosol and/or limiting the data exchange such that data exchange is performed only with the second aerosol generation device per the state in which the first aerosol generation device is generating aerosol. Limiting data exchange may comprise the control section 101 controlling the wireless communication interface 102 to prevent data exchange from being performed where said condition(s) are not satisfied.

Additionally or alternatively, performing data exchange with the second aerosol generation device may comprise, for example, at least one of:
transmitting, to the second aerosol generation device, data relating to device settings of the first aerosol generation device 100; and
receiving, from the second aerosol generation device, data relating to device settings of the second aerosol generation device 100.

The data relating to device settings may, for example, comprise at least one of:
data indicative of one or more heating profiles;
data indicative of an LED intensity;
data indicative of a passcode of a user;
data indicative of biometric information of the user;
data indicative of an identifier of the user; and
data indicative of a respective value for one or more configuration parameters.

In example embodiments in which the process of FIG. 2 comprises receiving data relating to device settings of the second aerosol generation device, the process of FIG. 2 may comprise a further optional process step of configuring the first aerosol generation device 100 based on the received data relating to device settings.

Additionally or alternatively, in example embodiments in which the process of FIG. 2 comprises transmitting data relating to device settings of the first aerosol generation device 200, such data may be for use by the second aerosol generation device in configuring its device settings.

Exchange of data relating to device settings may allow the first aerosol generation device 100 or the second aerosol generation device to automatically update configuration of its device settings, thereby avoiding the need for a user to manually provide input to said aerosol generation device in order to configure the device settings. This may be particularly advantageous where one of the first or second aerosol generation device is a new device of the user and the user wishes to copy their preferred configuration of device settings from their old device to their new device.

In addition, enabling automatic configuring or updating configuration of device settings in this way, may reduce or avoid the need to provide means for performing manual configuration, thereby helping to maintain a simple and non-complex user interface.

More generally, the process of FIG. 2 may optionally comprise an additional process step of outputting, via an output section 105 of the aerosol generation device 100, a notification to the user of the aerosol generation device 100 that the data exchange has been successfully performed.

The process of FIG. 2 requires two conditions to be satisfied in order for data exchange to be performed. In particular, the first aerosol generation device 100 must be in a predetermined state related to aerosol generation. Furthermore, at least one trigger event must be detected by the detection unit 103 while the first aerosol generation device 100 is in said predetermined state. Data exchange is only performed when both of these conditions are satisfied.

Therefore, aspects of the present invention enable secure and convenient data exchange between aerosol generation devices that is readily controllable by the aerosol generation device 100 and the user.

As such, aspects of the present invention may provide technical means required to facilitate new functionalities in aerosol generation devices, such as, for example, exchange of data between devices of a multiple different users to stimulate interaction and gamification between users.

By way of example, the aspects described herein may provide an underlying technical implementation for a first new functionality in which a user of aerosol generation device 100 is awarded a prize or other incentive for connecting with as many other users of respective aerosol generation devices as possible or for connecting with a specific number of other users of aerosol generation devices (e.g. 20).

Regarding the first new functionality, aspects of the present invention may facilitate exchange of data with the aerosol generation devices of other users including receiving an identifier of each other user, storing the identifiers of the other users in the memory section 104 and/or transmitting them to a server or other central entity for storing in association with other registered information of the user of aerosol generation device 100, and controlling the aerosol generation device 100 to output an indication to the user via output means 105 that a sufficient number of connections have been made.

By way of further example, the aspects described herein may provide an underlying technical implementation for a second new functionality in which a user of aerosol generation device 100 can exchange contact details with a user of another aerosol generation device in a simple and convenient manner. Contact details may be in the form of, for example, an email address, phone number, or identifier of a social media account.

Regarding the second new functionality, aspects of the present invention may facilitate exchange of data with the aerosol generation device of the other user including receiving an identifier of the other user and transmitting an identifier of the user of the aerosol generation device 100, storing the identifier of the other user in the memory section 104, and transmitting the identifier of the other user to a server or other central entity as part of a request for contact information of a user of the other aerosol generation device.

Such new functionalities may require each user of an aerosol generation device to register their information via a website, application or other platform, e.g. by creating an account, linked to a unique identifier of the user or of their aerosol generation device.

By way of example, the user may register their contact details and a preferred means of contact as part of the information on the platform and information indicative of the contact details of the other user may be received in a message sent via their preferred means of contact.

By way of further example, the prize or incentive may be provided to the user of the aerosol generation device via such a platform by the user accessing their user account and receiving their prize/incentive via an e-commerce website or mail, in addition to or alternatively to being collected in a store having suitable means to interface with the aerosol generation device to verify the number of connections made.

By enabling data exchange to be controlled by the aerosol generation device 100 to be limited to be performed only with particular devices and/or at particular times, aspects of the present invention also provide a technical implementation allowing manufacturers to easily and flexibly adapt data exchange to better suit such new functionalities.

For example, for either of the first and second new functionalities, data exchange may be limited so as to only be enabled during only vaping session. This may help to accelerate interaction among users by, in the example of the first new functionality, avoiding that a user can make a connection at any thus easily a time and reach predetermined number of new connections without actually using the aerosol generation device to generate aerosol. In contrast, a vaping session generally lasts only few second or few minutes, so that the interaction promoted by the first new functionality is improved.

By way of further example, for either of the first and second new functionalities, data exchange may also be enabled for a set period before and/or after vaping session. As described above, vaping session is generally relatively short in duration. As such, this alternative may allow for an improvement in flexibility. However, these additional periods should not be long duration, for example, less than one minute.

Although detailed embodiments have been described, they only serve to provide a better understanding of the invention defined by the independent claims, and are not to be seen as limiting.

1-15. (canceled)

16. An aerosol generation device comprising:
a wireless communication interface; and
circuitry configured to
activate the wireless communication interface while the aerosol generation device is in a predetermined state related to aerosol generation;
determine that at least one trigger event has been detected that is unrelated to the wireless communication interface; and
exchange data with another aerosol generation device via the wireless communication interface in response to detecting the at least one trigger event while the first aerosol generation device is in the predetermined state.

17. The aerosol generation device of claim 16, wherein the predetermined state comprises one of:
a state in which the aerosol generation device is generating aerosol;
a state comprising a predetermined duration after the aerosol generation device terminates generating aerosol;
a state in which the aerosol generation device is ready to generate aerosol; and
a state in which the aerosol generation device is activated by an input.

18. The aerosol generation device of claim 17, wherein:
the predetermined state comprises the state comprising the predetermined duration after the aerosol generation device terminates generating aerosol; and
the predetermined duration is shorter than a duration for generating aerosol.

19. The aerosol generation device of claim 17, wherein:
the predetermined state comprises the state in which the aerosol generation device is ready to generate aerosol; and
the aerosol generation device is ready to generate aerosol when an external power supply is disconnected.

20. The aerosol generation device of claim 17, wherein:
the predetermined state comprises the state in which the first aerosol generation device is ready to generate aerosol; and
the aerosol generation device is ready to generate aerosol when an aerosol precursor is inserted into the aerosol generation device.

21. The aerosol generation device of claim 16, further comprising:
a sensor configured to detect motion of the aerosol generating device.

22. The aerosol generating device of claim 21, wherein:
the at least one trigger event comprises a detection of a predetermined motion by the sensor.

23. The aerosol generation device of claim 22, wherein:
the sensor and/or the predetermined motion are independent of the aerosol generation device entering the predetermined state.

24. The aerosol generation device of claim 16, wherein:
the predetermined state comprises the state in which the aerosol generation device is generating aerosol; and
the circuitry is configured to determine that the aerosol generation device is in the state in which the aerosol generation device is generating aerosol during a predetermined period defined based on at least one of:
a supply of power to a heating element of the first aerosol generation device;
a detection of a user input in response to which the aerosol generation device initiates aerosol generation; and
a detection of an action by a user in response to which the aerosol generation device initiates aerosol generation.

25. The aerosol generation device of claim 24, wherein;
the circuitry is configured to limit the data exchange such that data exchange is performed only when the aerosol generation device is in the state in which the aerosol generation device is generating aerosol.

26. The aerosol generation device of claim 16, wherein performing data exchange with the another aerosol generation device comprises at least one of:
receiving an identifier of the another aerosol generation device from the another aerosol generation device and storing the identifier of the another aerosol generation device in memory of the aerosol generation device;
transmitting, to the another aerosol generation device, data relating to device settings of the aerosol generation device; and
receiving, from the another aerosol generation device, data relating to device settings of the another aerosol generation device.

27. The aerosol generation device of claim 26, wherein the data relating to device settings comprises at least one of:
data indicative of one or more heating profiles;
data indicative of an led intensity;
data indicative of a passcode of a user;
data indicative of biometric information of the user;
data indicative of an identifier of the user; and
data indicative of a respective value for one or more configuration parameters.

28. The aerosol generation device of claim 16, wherein:
the wireless communication interface comprises at least one of a bluetooth interface and a near field communication (nfc) interface.

29. The aerosol generation device of claim 16, further comprising:
a user interface configured to receive an input from a user of the aerosol generation device to initiate aerosol generation.

30. The aerosol generation device of claim 29, wherein
the at least one trigger event comprises a detection of an input received at the user interface to initiate aerosol generation.

31. The aerosol generation device of claim 16, further comprising:
a case configured to house at least the wireless communication interface and the circuitry.

32. The aerosol generation device of claim 16, wherein the circuitry is configured to:
activate the wireless communication interface when the aerosol generation device is in a state of generating aerosol;
determine that the at least one trigger event has been detected when an output of a sensor indicates that the aerosol generation device has been picked up by a user; and
initiate the data exchange with the another aerosol generation device in a case that the aerosol generation device is in a state of generating aerosol and the output of a sensor indicates that the aerosol generation device has been picked up by a user.

33. The aerosol generation device of claim 16, wherein:
the aerosol generation device is configured to generate aerosol by atomizing a liquid or imparting heat on a tobacco stick.

34. A method performed by an aerosol generating device, the method comprising:
activating a wireless communication interface while the aerosol generation device is in a predetermined state related to aerosol generation;
determining that at least one trigger event has been detected that is unrelated to the wireless communication interface; and
exchanging data with another aerosol generation device via the wireless communication interface in response to detecting the at least one trigger event while the first aerosol generation device is in the predetermined state.

35. A non-transitory computer-readable medium including computer program instructions, which when executed by circuitry of an aerosol generating device, cause the circuitry to:
activate the wireless communication interface while the aerosol generation device is in a predetermined state related to aerosol generation;
determine that at least one trigger event has been detected that is unrelated to the wireless communication interface; and
exchange data with another aerosol generation device via the wireless communication interface in response to detecting the at least one trigger event while the first aerosol generation device is in the predetermined state.
